(19) United States
(12) Patent Application Publication
(10) Pub. No.: US 2006/0239153 A1
(43) Pub. Date: Oct. 26, 2006

(54) Methods and circuits for automatic power control

(75) Inventors: Kuo-Ting Hsin, Hsinchu (TW); Ming-Jiou Yu, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/113,497

(22) Filed: Apr. 25, 2005

(51) Int. Cl. G11B 7/12

(52) U.S. Cl. 369/47.53

(57) ABSTRACT

A method of controlling write power for recording data into sectors of an optical storage medium. The optical storage medium comprises a plurality of sectors, each having a header, a data recording area, and a redundant area. The method comprises sampling a write power output from an optical emitter when the redundant area of the sectors is pointed thereby; generating a write power control force according to a deviation of the sampled write power from an ideal write power corresponding to a write power command; and adjusting the write power according to the write power error control force. Additionally, the redundant area is not a gap section or a mirror region. A circuit and method for determining whether to carry out automatic power control or not during recording data on an optical storage medium are also disclosed.

### BACKGROUND

The invention relates to data recording on an optical storage medium and, in particular, to automatic power control (APC) for recording data on an optical storage medium.

In general, data are recorded and reproduced on an optical storage medium such as an optical disc in a unit of area called a sector defined along a recording track. A sector typically comprises four sections, a header section providing physical identification data (PID), a gap section for controlling the laser power, a data section for recording information, and a buffer section for redundancy. The four sections are arranged successively in a sector. Data are recorded only in the data section. The laser power needs to be optimally controlled for recording and reproduction, respectively.

It is desirable to maintain the intensity of the laser beam on a storage medium at prescribed values while recording. If a laser diode is used as the laser source, the characteristic of light-emitting power against drive current changes dramatically with ambient temperature as well as the duration of the laser diode operation. FIGS. 1A and 1B show examples of the light emitting power vs. drive current characteristics of a laser diode, wherein the threshold value Iₜₕ denotes a drive current at which the laser diode starts to emit light. As shown in FIG. 1A, the threshold value Iₜₕ increases and the slope coefficient η or a slope of a curve of the light-emitting power vs. drive current characteristic decreases as the temperature increases. On the other hand, as shown in FIG. 1B, the threshold value Iₜₕ increases and the slope coefficient η decreases with long term operation of the laser. Thus, maintaining the drive current of a laser diode at prescribed values under various conditions is necessary. Therefore, in an apparatus for recording and reproducing information optically, the laser is controlled so as to maintain the optical intensity of the laser beam on an optical storage medium at prescribed values.

FIG. 2 is a block diagram of an optical recording circuit with automatic power control (APC). A photodiode 17 detects a light originally generated by a laser diode 16 and generates a photocurrent proportional to the laser power. A current-to-voltage (I/V) converter 18 converts the photocurrent to a voltage. The voltage is sampled by a sample and hold (S/H) circuit 10 and then compared with an erase power command 11 in an erase power loop error compensator 12. As a result, an erase power loop error compensator 12 generates an erase power control force for the laser driver 13. The laser diode driver 13 thus adjusts the laser power of a laser diode 16 accordingly. The closed loop system enables the erase power generation exactly following the erase power command 11. Accordingly, the laser power is very stable and unaffected by temperature variation. As for write power control, an open loop is typically used with reference to the erase power for write power estimation. In FIG. 2, a write power command 14 controls the laser driver 13 through a mapping table for adjusting the write laser power of the laser diode 16.

FIG. 3 shows waveforms of signals required for data recording on an optical storage medium. A signal WPC in FIG. 3 stands for a waveform of a write pulse combination for recording. A write pulse with multi-pulse waveform is used to form pits, while an erase pulse with DC level is used to form lands. Signals WFPDSH and EFPDSH are respectively pulled high when pits and lands are formed. An output signal of the photodiode is sampled as a feedback signal of the closed loop automatic power control (APC) system. When a land is formed, a DC erase power is used for APC. The signal EFPDSH can control the S/H circuit to sample an output signal of the I/V converter, which is relative to the output power of the photodiode. Since a multi-pulse write pulse is used to burn pits, and the laser power switches rapidly, the output bandwidth of the photodiode is limited and the photodiode & I/V converter cannot respond to the power transition in time. The S/H circuit requires a period to settle the sampled signal. Accordingly, APC may not be carried out for calibrating the write power during a write period. The write power of the laser diode is typically adjusted through a mapping table or prediction methods based on an APC calibrated erase power. However, such methods are more suitable for laser diodes with a linear output characteristic. In most cases, a laser diode has a non-linear output characteristic. Thus, the write power is not precisely controlled and is not stable.

### SUMMARY

An embodiment of a write power control method for recording data into sectors of an optical storage medium comprises sampling a write power output from an optical emitter when a redundant area of the sectors is pointed thereby; generating a write power control force according to a deviation of the sampled write power from an ideal write power corresponding to a write power command; and adjusting the write power according to the write power error control force. The optical storage medium comprises a plurality of sectors, each having a header, a data recording area, and a redundant area.

An embodiment of a method for determining when to carry out automatic power control comprises starting a counter when accessing the beginning of a sector; generating a redundant area start signal when a redundant area in the sector is going to be accessed; latching a value of the counter according to the redundant area start signal; and starting automatic power control if the latched counter value is less than a first threshold value.

An embodiment of a circuit for determining when to carry out automatic power control comprises a counter, a decision circuit, an encoder, a normal write strategy generator, a multiplexer, a laser diode driver, an automatic power control circuit, a sample and hold circuit, and an automatic power control pulse generator. The decision circuit, latching a value of the counter and generating a selection signal accordingly, has an input coupled to the counter. The encoder has an output coupled to the decision circuit. The normal write strategy generator has an input coupled to the encoder. The multiplexer has a first data input coupled to the normal write strategy generator and a selection input, receiving the selection signal, coupled to the decision circuit. The laser diode driver is coupled to an output of the multiplexer. The automatic power control circuit, controlling the laser diode driver to adjust a power of a laser diode, is coupled to the laser diode driver. The sample and hold circuit, feeding back the power of the laser diode, is coupled to the automatic power control circuit. The automatic power control pulse generator is coupled to the sample and hold circuit and a second data input of the multiplexer.

### DESCRIPTION OF THE DRAWINGS

FIGS. 1A and 1B show examples of the light emitting power vs. drive current characteristic of a laser diode.

FIG. 2 shows a block diagram of an optical recording circuit for automatic power control (APC).

FIG. 3 shows signals generated for recording data on an optical storage medium.

FIG. 4A shows a sector field layout of a rewritable data zone.

FIG. 4B shows actions of a counter according to an embodiment of the invention.

FIG. 4C shows physical identification data used for synchronization according to an embodiment of the invention.

FIG. 5 is a flowchart showing a method for determining whether to carry out automatic power control or not during data recording according to an embodiment of the invention.

FIG. 6 shows a circuit for determining whether to carry out automatic power control or not during data recording according to an embodiment of the invention.

FIG. 7 shows a block diagram of the automatic power control circuit shown in FIG. 6 according to an embodiment of the invention.

FIG. 8A shows an exemplary EFM pattern output from the encoder for normal writing.

FIGS. 8B and 8C respectively show exemplary waveforms of a write pulse and an erase pulse corresponding to the EFM pattern shown in FIG. 8A.

FIG. 8D shows a write pulse combination derived from the write and erase pulses shown in FIGS. 8B and 8C.

FIG. 8E shows a signal EFPDSH corresponding to the EFM pattern shown in FIG. 8A for controlling the sample and hold circuit during normal writing.

FIG. 8F shows a sector field layout of an optical storage medium.

FIG. 8G shows an exemplary EFM pattern output from the encoder for carrying out write power APC.

FIGS. 8H and 8I respectively show exemplary waveforms of a write pulse and an erase pulse corresponding to the EFM pattern shown in FIG. 8G.

FIG. 8J shows a write pulse combination derived from the write and erase pulses shown in FIGS. 8H and 8I.

FIG. 8K shows a signal WFPDSH corresponding to the EFM pattern shown in FIG. 8G for controlling the sample and hold circuit during APC writing.

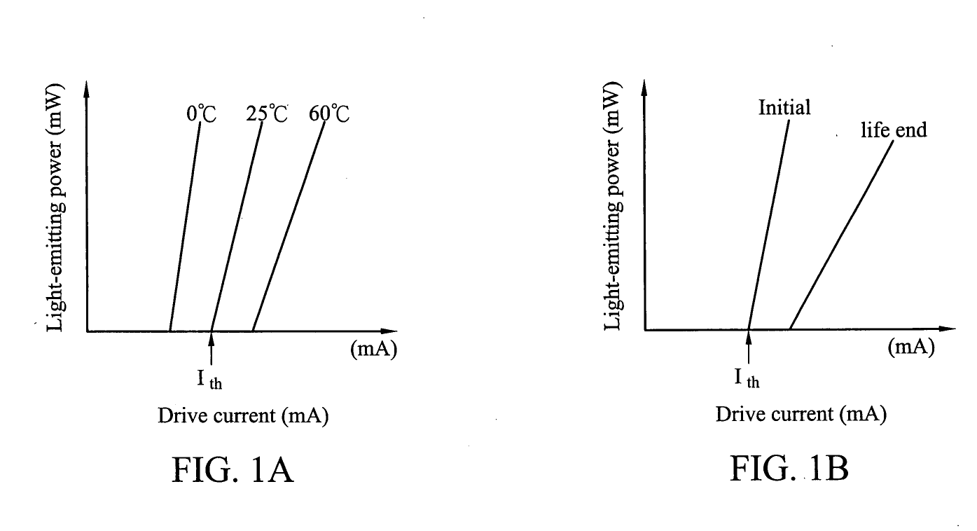

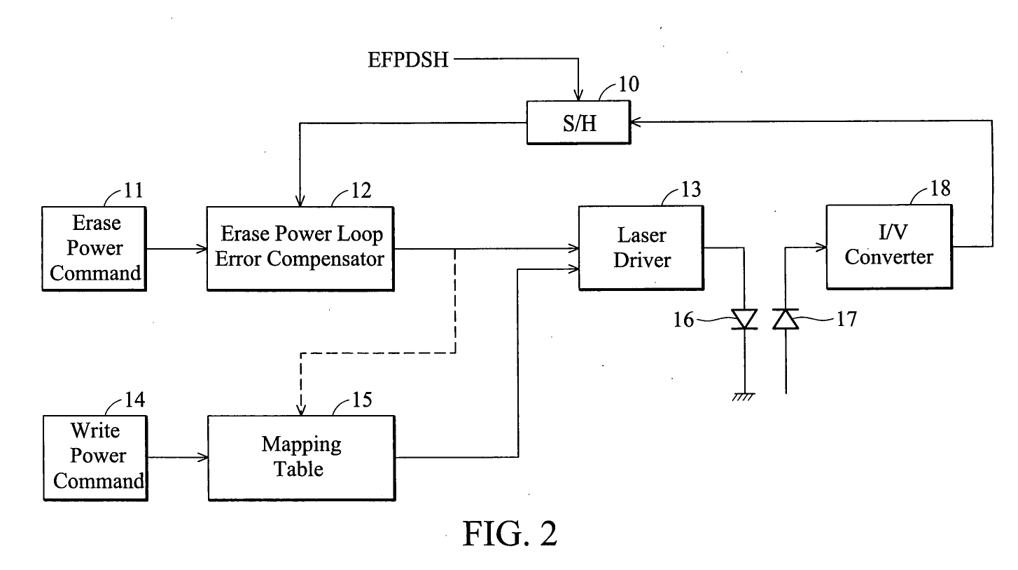

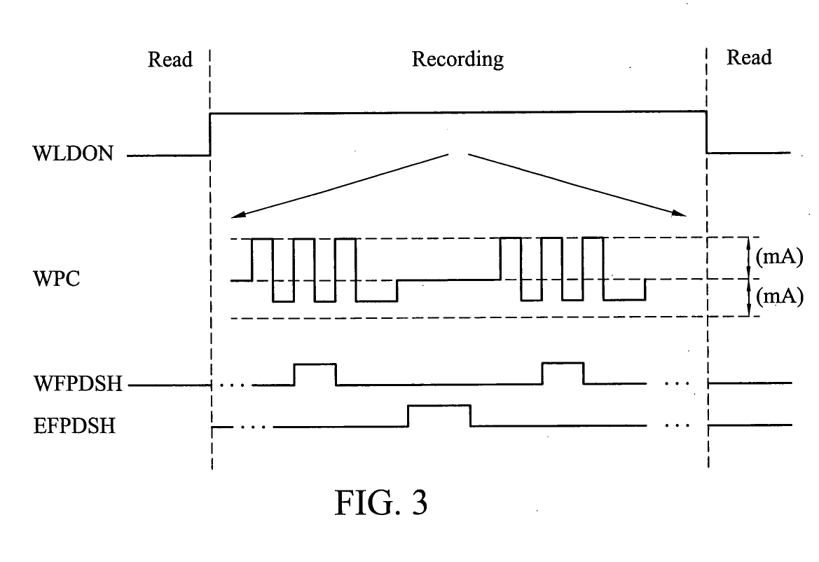

### DETAILED DESCRIPTION

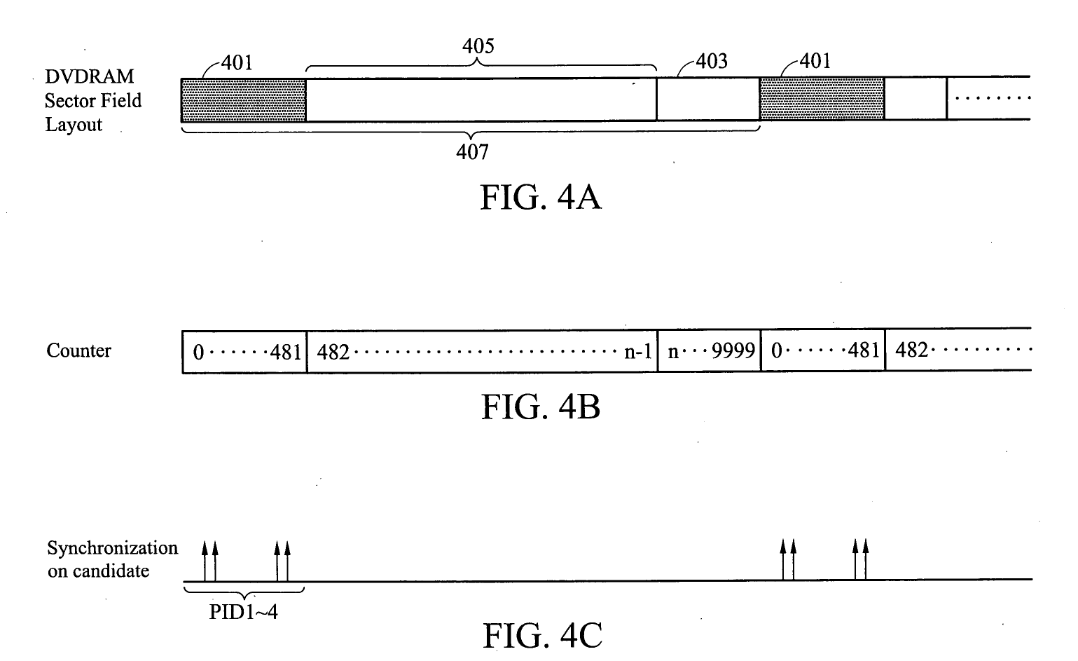

According to the specification of a DVD-RAM format, a sector field layout of a rewritable data zone is shown in FIG. 4A. The regions in a sector 407 other than header 401 are all recordable fields. A buffer section 403 therein has a length of 24 to 25 Bytes, i.e. 384 to 400 channel bits. The content in the buffer section 403 is negligible during normal reading. Due to track run-out or spindle spin speed variations, an actual length of data recording is different from a physical length of a data recording area 405. The buffer section 403 provides a redundant area for data recording when the actual length of data is longer than the physical length of the data recording area 405. Thus, the header 401 of a next sector is prevented from damaged by the laser power during optical recording. Additionally, there is no data loss in optical recording when the actual length of data exceeds the length of the data recording area 405.

For DVD-RAM, a spindle spins at a zoned constant linear velocity (ZCLV). Under the same spinning speed, 2× for example, the data transfer rate is the same for any track in the same zone. A time period of each sector is fixed. A counter for timing utilizes a fixed clock instead of a wobble clock. Theoretically, a final counter value for each sector field is the same. To make the counter more reliable, physical identification data PID1˜4 are used for synchronization, as shown in FIG. 4C. When one of the physical identification data PID1˜4 is decoded, a corresponding counter value is reloaded into the counter.

Take a 2× transfer rate for example, a counter counts from 0 to 9999 with a fixed clock frequency of 13.53MHz for each sector, as shown in FIG. 4B. There are 2697 Bytes in a sector field and the header therein has a length of 130 Bytes. Accordingly, the counter counts to about 481 (which is derived by (130/2697)×10000−1) at the end of the header. There are 24 to 25 Bytes in the buffer section. When the buffer section starts, the counter value is between 9906 (((2697−25)/2697)×10000−1) and 9910 (((2697−24)/2697)×10000−1), the value n in FIG. 4B is thus between 9906 and 9910. The counter value, however, may count to a value not within a range between 9906 and 9910 due to track run-out or spindle spin speed variations. If the counter value is larger than 9910, the actual length of data recording in the sector is longer than the physical length of the data recording area of the sector, and a part of the buffer section is used for data recording. If the counter value is smaller than 9906, the actual length of data recording in the sector is shorter than the physical length of the data recording area of the sector, which extends the recordable area of the sector.

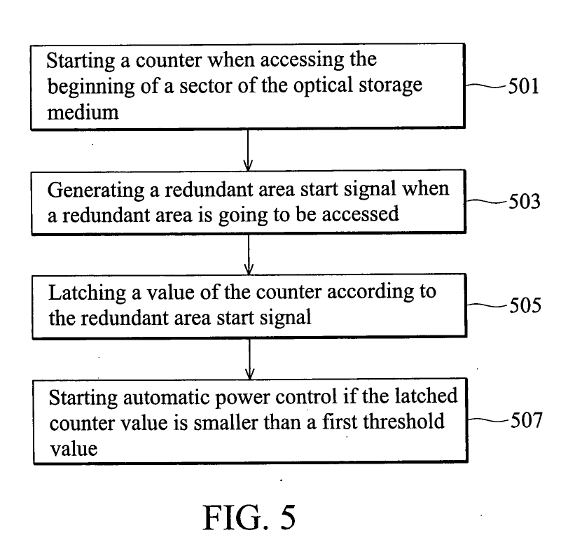

FIG. 5 shows an embodiment of a method for determining whether to carry out automatic power control or not during data recording. The method comprises starting a counter when accessing the beginning of a sector of the optical storage medium (step 501); generating a redundant area start signal when a redundant area is going to be accessed (step 503); latching a value of the counter according to the redundant area start signal (step 505), and starting automatic power control if the latched counter value is smaller than a first threshold value (step 507). The optical storage medium comprises a plurality of sectors, and each sector comprises a header, a data recording area, and a redundant area. More specifically, the optical storage medium is an optical disc with a DVD-RAM format, and the sector field layout for DVD-RAM is shown in FIG. 4A, where the redundant area is the buffer section 403. Preferably, the buffer section 403 follows the data recording area 405. If the counter value latched at the beginning of the buffer section 403 is smaller than a first threshold value, for example, 9930 in the case of FIG. 4B, the buffer section 403 can be used for write power control. To the contrary, if the counter value latched at the beginning of the buffer section 403 is larger than the first threshold value, there is not enough space for automatic power control, and the automatic power control will not be activated. To prevent damage to the header of a subsequent sector by the write power, the automatic power control has to end before accessing the next header. Accordingly, a second threshold can be set to stop the automatic power control. If the counter value is larger than the second threshold, 9980 for example, the automatic power control is stopped.

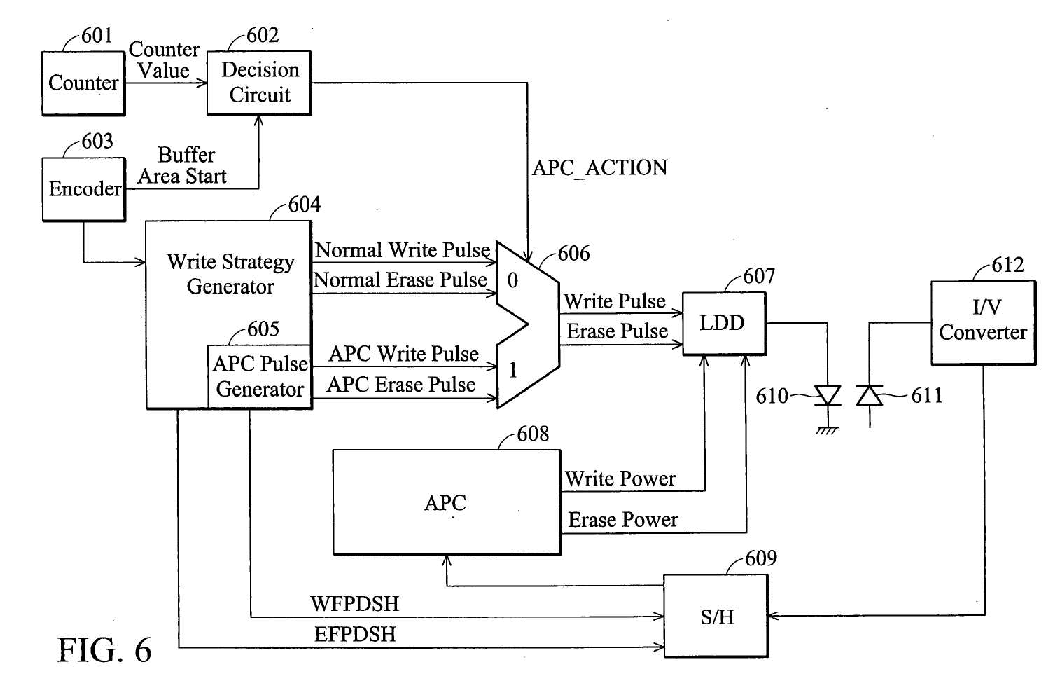

FIG. 6 shows an embodiment of a circuit for determining whether to carry out automatic laser power control or not for optical recording. The circuit comprises a counter 601, a decision circuit 602, an encoder 603, a write strategy generator 604, a multiplexer 606, a laser diode driver (LDD) 607, an automatic power control (APC) circuit 608, a sample and hold (S/H) circuit 609, and an automatic power control pulse generator 605. The decision circuit 602 has an input coupled to the counter 601. The decision circuit 602 latches a value of the counter and generates a selection signal APC_ACTION accordingly. The encoder 603 has an output coupled to the decision circuit 602. The write strategy generator 604 has an input coupled to the encoder 603. The automatic power control pulse generator 605 is coupled to the encoder 603 for generating a write pulse and an erase pulse for recording a redundant area of the optical storage medium. The multiplexer 606 has a first data input coupled to the write strategy generator 604, a second data input coupled to the automatic power control pulse generator 605, and a selection input coupled to the decision circuit 602. The laser diode driver 607 is coupled to an output of the multiplexer 606. The automatic power control circuit 608 is coupled to the laser diode driver 607. The sample and hold circuit 609 is coupled to the automatic power control circuit 608.

Take a 2× transfer rate for example, the counter 601 counts from 0 to 9999 with a fixed clock frequency of 13.53MHz for each sector. During normal data recording, the counter 601 counts from 482 to n−1as shown in FIG. 4B. The encoder 603 provides encoded data to the write strategy generator 604 during normal data recording. When normal data recording ends, the encoder 601 transmits a redundant area start signal to the decision circuit 602. The decision 602 latches the counter value n when receiving the redundant area start signal from the encoder 601. If the counter value n latched at the beginning of the buffer section is smaller than a first threshold value, the output signal APC_ACTION of the decision circuit 602 is pulled high. When the output signal APC_ACTION of the decision circuit 602 is at a high state, the multiplexer 606 selects output signals, an APC write pulse and an APC erase pulse, of the APC pulse generator 605, and outputs them to the laser diode driver 607. The laser diode 607 also receives output signals, a write power and an erase power, of the automatic power control circuit 608, and generates a driving current to drive the laser diode 610 according to the received signals. The photo diode 611 generates a current proportional to the laser power, and the current is converted to a voltage by an I/V converter 612. The voltage is sampled by a sample and hold circuit 609 and transmitted to the automatic power control circuit 608 to control the write power and erase power.

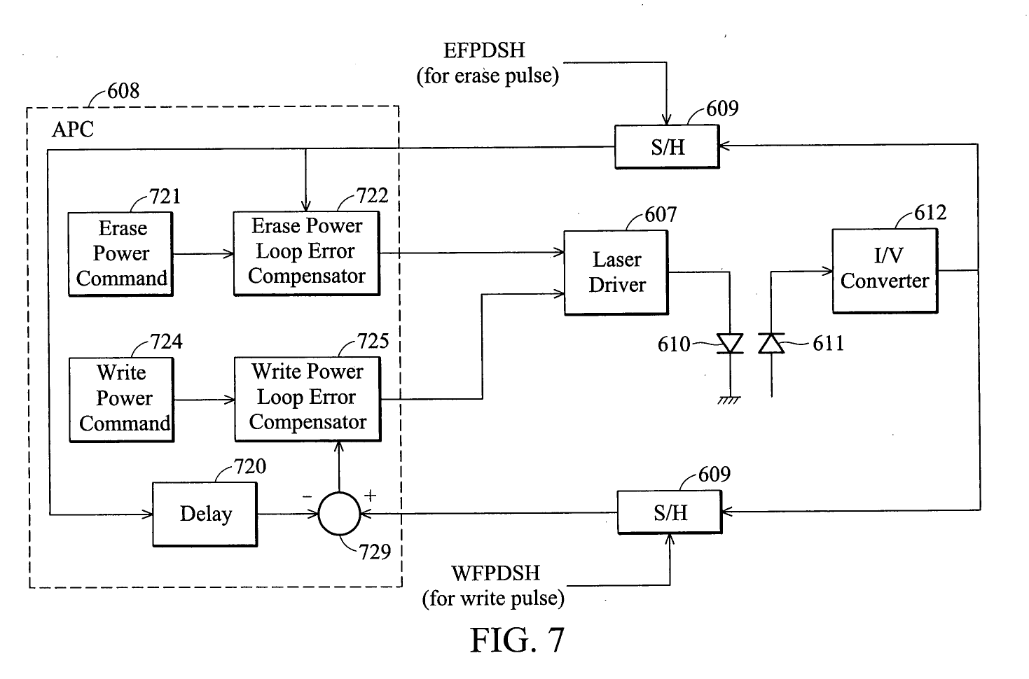

FIG. 7 shows a block diagram of the automatic power control circuit shown in FIG. 6 according to an embodiment of the invention. The automatic power control circuit 608 comprises an erase power loop error compensator 722, a delay 720, a substractor 729, and a write power loop error compensator 725. The erase power loop error compensator 722 receives an erase power command 721. The delay 720 is coupled to the sample and hold circuit 609. The subtractor 729 has inputs respectively coupled to the delay 720 and the sample and hold circuit 609. The write power loop error compensator 725 is coupled to an output of the subtractor 729. The write power loop error compensator 725 also receives a write power command 724.

In FIG. 7, the photo diode 611 generates a current proportional to the laser power and the current is converted to a voltage by an I/V converter 612. In an erase power loop, the voltage is sampled by the sample and hold circuit 609 and compared with an erase power command 721 in the erase power loop error compensator 722. As a result, the erase power loop error compensator 722 generates an erase power control force, and the laser diode driver 607 adjusts the erase power of the laser diode 610 according thereto. Thus, a closed erase power loop system is formed. The closed loop system enables the erase laser power generation exactly following the erase power command 721. Accordingly, the laser erase power is very stable and is not affected by temperature variation.

The erase laser power sampled by the sample and hold circuit 609 is transmitted to the subtractor 729 via a delay unit 720. In a write power loop, the write laser power is sampled by the sample and hold circuit 609 and subtracted by the feedback erase laser power such that a write power control force corresponding to the write power command 724 is generated by the write power loop error compensator 725. As a result, the laser diode driver 607 adjusts the write power of the laser diode 610 according to the write power control force. Thus, a closed write power loop system is formed. The closed loop system enables the write laser power generation exactly following the write power command 724. Accordingly, the laser write power is very stable and is not affected by temperature variation.

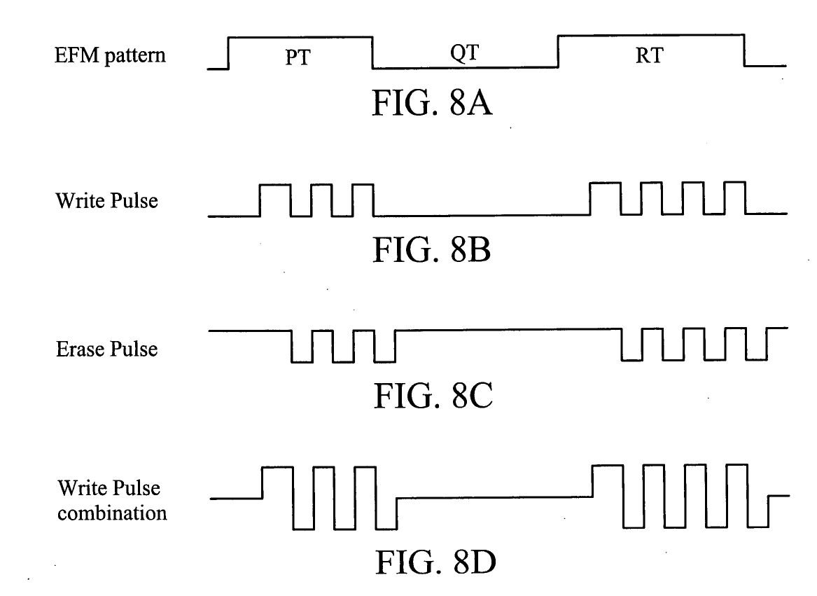

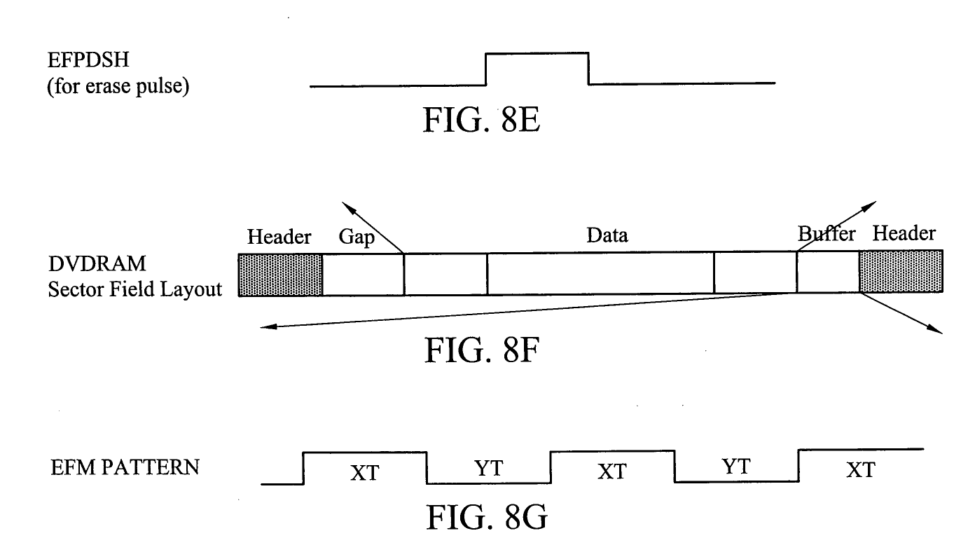

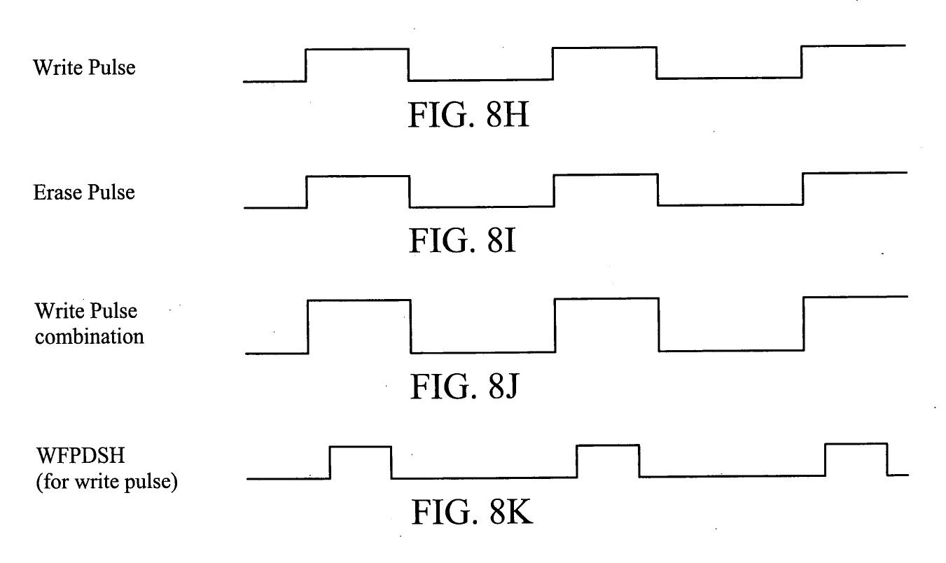

FIGS. 8A˜8K illustrate waveforms of signals for laser write and erase power control according to an embodiment of the invention. FIG. BA shows an exemplary EFM pattern output from the encoder for optical recording during normal writing. FIGS. 8B and 8C respectively show waveforms of a write pulse and an erase pulse corresponding to the EFM pattern of FIG. 8A. FIG. 8D shows a normal write pulse combination derived by combining the pulses of FIGS. 8B and 8C during normal writing. FIG. 8E shows a signal EFPDSH controlling the sample and hold circuit to sample the output signal of the photo diode. The sampled value reflects the erase power during normal writing, and can be used to control laser power. FIG. 8F shows a sector field layout of an optical storage medium, and normal writing includes recording data on the data section. FIG. 8G shows an exemplary EFM pattern output from the encoder for carrying out write power APC in a redundant area. FIGS. 8H and 8I respectively show waveforms of a write pulse and an erase pulse for carrying out write power APC in a redundant area. FIG. 8J shows a write pulse combination derived by combining the pulses of FIGS. 8H and 8I for carrying out write power APC in a redundant area. FIG. 8K shows a signal WFPDSH controlling the sample and hold circuit for carrying out write power APC in a redundant area. Write power APC is carried out in a buffer section as shown in FIG. 8F. An encoder generates an EFM pattern of FIG. 8G having pits with a length of XT and lands with a length of YT. The waveforms of write and erase pulses shown in FIGS. 8H and 8I correspond to the EFM pattern of FIG. 8G, and the combination of the write and erase pulses is shown in FIG. 8J. Control signal WFPDSH shown in FIG. 8K controls the sample and hold circuit to sample the output signal of the photo diode. The sampled value reflects the write power. As long as the length of lands (YT) is well controlled, an output signal of the photodiode exactly reflects the write power and therefore can be used as a feedback signal for write power APC. On the other hand, the normal write pulse combination and the corresponding signal EFPDSH are used for erase power APC during normal writing.

While the invention has been described by way of example and in terms of preferred embodiment, it is to be understood that the invention is not limited thereto. To the contrary, it is intended to cover various modifications and the advantages would be apparent to those skilled in the art. Therefore, the scope of the appended claims should be accorded the broadest interpretation so as to encompass all such modifications.

What is claimed is:

1. A method of controlling write power for recording data into sectors of an optical storage medium, each sector having a header, a data recording area, and a redundant area, the method comprising the steps of:
sampling a write power output from an optical emitter when the redundant area of the sectors is pointed thereby;
generating a write power control force according to a deviation of the sampled write power from an ideal write power corresponding to a write power command; and
adjusting the write power according to the write power control force;
wherein the redundant area is not a gap section or a mirror region of the sector.

2. The method as claimed in claim 1, further comprising the steps of:
providing an erase pulse for the optical emitter;
sampling an erase power output from the optical emitter; and
providing a write pulse combination when the redundant area is pointed by the optical emitter;
wherein in the step of generating a write power control force, the write power control force is generated by comparing a difference between the sampled write and erase power with a write power command.

3. The method as claimed in claim 1, wherein the redundant area is a buffer section.

4. A method for determining whether to carry out automatic power control or not during recording data into sectors of an optical storage medium, the method comprising the steps of:
starting a counter when accessing the beginning of a sector, wherein each sector comprises a header, a data recording area, and a redundant area;
generating a redundant area start signal when the redundant area is going to be accessed;
latching a value of the counter according to the redundant area start signal; and
starting automatic power control if the latched counter value is less than a first threshold value.

5. The method as claimed in claim 3, further comprising the step of stopping automatic power control if the latched counter value exceeds a second threshold value.

6. The method as claimed in claim 3, wherein the redundant area is a buffer section.

7. A circuit for determining whether to carry out automatic power control or not during recording data on an optical storage medium, the circuit comprising:
a counter;
a decision circuit, latching a value of the counter and generating a selection signal accordingly;
an encoder coupled to the decision circuit;
a write strategy generator coupled to the encoder for generating a write pulse and an erase pulse for recording a data recording area;
an automatic power control pulse generator coupled to the encoder for generating a write pulse and an erase pulse for recording a redundant area of the optical storage medium;
a multiplexer with a first data input coupled to the write strategy generator, a second data input coupled to the automatic power control pulse generator, and a selection input coupled to the decision circuit;
a laser diode driver coupled to an output of the multiplexer for driving a laser diode;
a sample and hold circuit, sampling the power of the laser diode; and
an automatic power control circuit, controlling the laser diode driver to adjust the power of the laser diode according to an output of the sample and hold circuit.

8. The circuit as claimed in claim 6, wherein the automatic power control circuit comprises:
an erase power loop error compensator controlling the laser driver by comparing the output of the sample and hold circuit and an erase power command;
a delay coupled to the sample and hold circuit;
a substractor with inputs respectively coupled to the delay and the sample and hold circuit; and
a write power loop error compensator controlling the laser driver by comparing an output of the substractor and a write power command.

9. The circuit as claimed in claim 6, wherein the optical storage medium comprises a plurality of sectors, each comprising a header, a data recording area, and a redundant area.

10. The circuit as claimed in claim 6, wherein the data recording area is followed by the redundant area.

11. The circuit as claimed in claim 6, wherein the redundant area is a buffer section.
